(19) United States
(12) Patent Application Publication
(10) Pub. No.: US 2025/0128663 A1
(43) Pub. Date: Apr. 24, 2025

(54) Trailer Step Bracket Device

(71) Applicant: Russell Hart, Chillicothe, MO (US)

(72) Inventor: Russell Hart, Chillicothe, MO (US)

(21) Appl. No.: 18/917,195

(22) Filed: Oct. 16, 2024

Related U.S. Application Data
(60) Provisional application No. 63/591,574, filed on Oct. 19, 2023.

(51) Int. Cl. B60R 3/02

(52) U.S. Cl. CPC B60R 3/02

(57) ABSTRACT

A trailer step bracket designed for attachment to a flatbed trailer to support fold-out camper or trailer steps is disclosed. The trailer step bracket comprises a pair of symmetrical mounting plates, each featuring a long arm and a parallel short arm integrated (i.e., connected) by a transverse arm, with steps-supporting horizontal arms extending from the long arms. The horizontal arms are connected by a bracket disposed perpendicular (i.e., transverse) thereto and includes apertures for securing the fold-out camper or trailer steps. A detachable pivot member is fastened to the top surface of the bracket for accommodating a user's weight. The steps can be expanded or folded for ease of use. The bracket is constructed from durable material, such as steel or aluminum. Reflective strips may be added for visibility in low light conditions.

### CROSS-REFERENCE TO RELATED APPLICATION

The present application claims priority to, and the benefit of, U.S. Provisional Application No. 63/591,574 which was filed on Oct. 19, 2023 and is incorporated herein by reference in its entirety.

### FIELD OF THE INVENTION

The present invention generally relates to the field of trailers. More specifically, the present invention relates to a novel step system for getting up and onto a trailer, into an RV, into a pickup truck bed, and more. The step bracket is attached to a flatbed trailer, wherein the step bracket is bolted onto any set of fold out camper or trailer steps to enable the user to safely enter or exit his or her trailer. The device is mounted using arms and improves safety when entering and exiting a trailer, RV, etc., minimizing physical effort needed to climb onto the trailer or vehicle. Accordingly, the present disclosure makes specific reference thereto. Nonetheless, it is to be appreciated that aspects of the present invention are also equally applicable to other like applications, devices, and methods of manufacture.

### BACKGROUND

By way of background, flatbed trailers and other types of trailers are used for carrying cargo. However, such trailers pose challenges for individuals attempting to step up onto or pull their body weight onto the trailer. The height of the trailer platform often necessitates considerable physical effort, which can be particularly difficult for individuals with limited strength or mobility. The difficulty increases the risk of strain or injury during the process of getting onto the trailer. Furthermore, once on the trailer, the act of jumping or hopping off can be dangerous as well. The impact from jumping off a high platform can lead to muscle strains, twisted ankles, or more severe injuries. Additionally, there is a risk of hitting extremities, such as hands, feet, or shins, against the hard edges of the trailer, leading to bruises or fractures.

Conventional steps and stepping aids often fail to provide a safe and effective solution. They may lack the necessary height to bridge the gap between the ground and the trailer platform adequately. Individuals desire a device that can be used with steps to expand the capacity of the fold-out camper or trailer steps.

Therefore, there exists a long felt need in the art for a reliable and convenient device to assist individuals in safely accessing trailers. There is also a long felt need in the art for a trailer step bracket that securely supports fold-out camper or trailer steps that enhances both the safety and ease of trailer access. Additionally, there is a long felt need in the art for a special device that can be mounted to a trailer to eliminate jumping or hopping off by an individual in order to get down from the trailer. Moreover, there is a long felt need in the art for a uniquely designed trailer step bracket that can be used with conventional fold-out steps for trailers. Further, there is a long felt need in the art for a device that expands the steps for easy access onto and off the trailer. Furthermore, there is a long felt need in the art for a trailer step bracket that enhances safety and accessibility for trailer users, making it easier to enter and exit the trailer. Finally, there is a long felt need in the art for a uniquely designed bracket device that can be attached to a trailer and used with conventional steps to safely and easily assist users in stepping up or down from a trailer.

The subject matter disclosed and claimed herein, in one embodiment thereof, comprises a trailer step bracket for expanding fold-out camper or trailer steps. The bracket device includes a first mounting plate including a long arm and a parallel short arm, the arms are integrated (i.e., connected) by a transverse arm at their top ends, and a steps-supporting horizontal arm extends from the bottom end of the long arm, a second mounting plate including a long arm and a parallel short arm, the arms are integrated (i.e., connected) by a transverse arm at their top ends, and a steps-supporting horizontal arm extends from the bottom end of the long arm, a bracket is disposed in a direction perpendicular (i.e., transverse) to the horizontal arms and integrated (i.e., connected) to the distal ends of the horizontal arms, at least two apertures disposed on the horizontal arms for securing fold-out camper or trailer steps, and a pivot member is fastened to the top surface of the bracket for accommodating the weight of a user.

In this manner, the trailer step bracket device of the present invention accomplishes all of the forgoing objectives and provides users with a novel bracket device that provides a stable and secure platform for stepping up onto and down from a trailer, reducing the risk of slips, falls, and associated injuries. The fold-out steps can be used easily and expanded or folded, offering convenience for users when entering or exiting the trailer. The trailer step bracket is compatible with various types of trailers, including flatbeds and RVs, making it a solution for different users. The device provides an accessible stepping solution for individuals with limited mobility or physical strength, making it easier for users to access trailers without assistance. The bracket device is designed to support a significant weight capacity, accommodating not only the user but also any loads they might carry, ensuring reliable performance under various conditions.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a trailer step bracket for attaching to a flatbed trailer and supporting fold-out camper or trailer steps. The bracket device includes a first mounting plate including a long arm and a parallel short arm, the arms are integrated (i.e., connected) by a transverse arm at their top ends, and a steps-supporting horizontal arm extends from the bottom end of the long arm, a second mounting plate including a long arm and a parallel short arm, the arms are integrated (i.e., connected) by a transverse arm at their top ends, and a steps-supporting horizontal arm extends from the bottom end of the long arm, a bracket is disposed in a direction perpendicular (i.e., transverse) to the horizontal arms and integrated (i.e., connected) to the distal ends of the horizontal arms, at least two apertures disposed on the horizontal arms for securing fold-out camper or trailer steps, and a pivot member is detachably and rotatably fastened to the top surface of the bracket for accommodating the weight of a user.

In yet another embodiment, a combined steps and bracket device for attachment to a trailer is disclosed. The combination includes a trailer step bracket including a pair of symmetrical mounting plates each having a long arm, a parallel short arm, and a transverse arm at their top ends, steps-supporting horizontal arms extending from the bottom ends of the long arms, a bracket disposed in a direction perpendicular (i.e., transverse) to the horizontal arms and integrated (i.e., connected) to the distal ends of the horizontal arms, at least two apertures on the horizontal arms for securing fold-out camper or trailer steps, a pivot member detachably and rotatably fastened to the top surface of the bracket. The fold-out camper or trailer steps includes a plurality of foldable steps wherein the fold-out camper or trailer steps is secured to the horizontal arms of the trailer step bracket through the apertures.

In another aspect, a method of installing a trailer step bracket to a flatbed trailer is disclosed. The method includes the steps of positioning a trailer step bracket having a first and second mounting plate, each with a long arm, a parallel short arm, and a transverse arm at their top ends, and steps-supporting horizontal arms extending from the bottom ends of the long arms, against the trailer, aligning apertures on the horizontal arms of the trailer step bracket with corresponding mounting points on fold-out camper or trailer steps, securing the fold-out camper or trailer steps to the horizontal arms of the trailer step bracket using fasteners through the apertures, and positioning a pivot member detachably and rotatably fastened to the top surface of the bracket to accommodate the weight of a user.

In another aspect, the bracket is L-shaped and includes a first member substantially horizontal and parallel to the ground when mounted to a trailer, and a corresponding transverse member extends transversely from an edge of the first member.

In still another embodiment, the trailer step bracket includes reflective strips or markings on the bracket for visibility in low light conditions.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of the trailer step bracket of the present invention in accordance with the disclosed structure;

FIG. 2 illustrates a standalone view of the bracket used in the trailer step bracket of the present invention in accordance with the disclosed structure;

FIG. 3 illustrates a perspective view showing the trailer step bracket mounted to a trailer for safe use in accordance with the disclosed structure;

FIG. 4 illustrates a perspective view showing the trailer step bracket mounted to a trailer for safe use in accordance with the disclosed structure; and

FIG. 5 illustrates a perspective view showing the trailer step bracket device of the present invention with the steps in a folded state in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for a reliable and convenient device to assist individuals in safely accessing trailers. There is also a long felt need in the art for a trailer step bracket that securely supports fold-out camper or trailer steps that enhances both the safety and ease of trailer access. Additionally, there is a long felt need in the art for a special device that can be mounted to a trailer to eliminate jumping or hopping off by an individual in order to get down from the trailer. Moreover, there is a long felt need in the art for a uniquely designed trailer step bracket that can be used with conventional fold-out steps for trailers. Further, there is a long felt need in the art for a device that expands the steps for easy access onto and off the trailer. Furthermore, there is a long felt need in the art for a trailer step bracket that enhances safety and accessibility for trailer users, making it easier to enter and exit the trailer. Finally, there is a long felt need in the art for a uniquely designed bracket device that can be attached to a trailer and used with conventional steps to safely and easily assist users in stepping up or down from a trailer.

The present invention, in one exemplary embodiment, is a combined steps and bracket device for attachment to a trailer. The combination includes a trailer step bracket including a pair of symmetrical mounting plates each having a long arm, a parallel short arm, and a transverse arm at their top ends, steps-supporting horizontal arms extending from the bottom ends of the long arms, a bracket disposed in a direction perpendicular (i.e., transverse) to the horizontal arms and integrated (i.e., connected) to the distal ends of the horizontal arms, at least two apertures on the horizontal arms for securing fold-out camper or trailer steps, a pivot member detachably and rotatably fastened to the top surface of the bracket. The fold-out camper or trailer steps includes a plurality of foldable steps wherein the fold-out camper or trailer steps is secured to the horizontal arms of the trailer step bracket through the apertures.

Reference will now be made in detail to the present preferred embodiments of the invention, examples of which are illustrated in the accompanying drawings. Wherever possible, the same reference numerals are used in the drawings and the description to refer to the same or like parts.

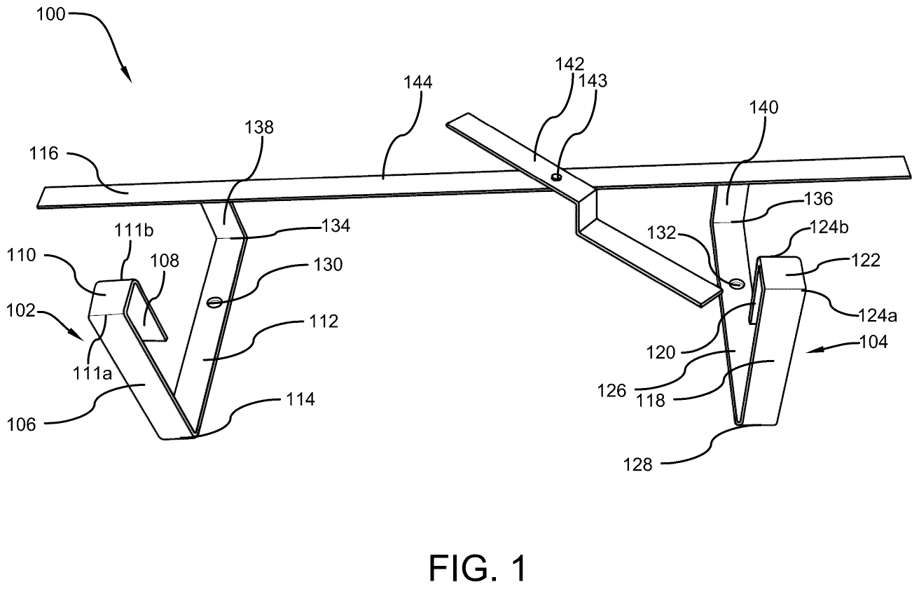

Referring initially to the drawings, FIG. 1 illustrates a perspective view of trailer step bracket of the present invention in accordance with the disclosed structure. The trailer step bracket 100 of the present invention is designed to be attached to a flatbed trailer and to support standard fold-out camper or trailer steps. More specifically, the trailer step bracket 100 includes a pair of symmetrical mounting plates 102, 104. The first plate 102 includes a long arm 106 and a parallel short arm 108 wherein the arms 106, 108 are integrated (i.e., connected) by a transverse arm 110 at the top ends 111a, 111b of the arms 106, 108. A steps-supporting horizontal arm 112 extends from the bottom end 114 of the long arm 106 and extends to a bracket 116.

The second mounting plate 104 includes a long arm 118 and a parallel short arm 120, The arms 118, 120 are integrated (i.e., connected) by a transverse arm 122 at the top ends 124a, 124b of the arms 118, 120 respectively. A steps-supporting horizontal arm 126 extends from the bottom end 128 of the long arm 118 and extends to the bracket 116.

Two symmetrical apertures 130, 132 are disposed on the horizontal arms 112, 126 for fastening and securing fold-out camper or trailer steps to the trailer step bracket 100 of the present invention. The apertures 130, 132 can be used for securing any conventional fold-out camper or trailer steps. The bracket 116 is substantially horizontal and is disposed in a direction perpendicular (i.e., transverse) to the horizontal arms 112, 126. The distal ends 134, 136 of the horizontal arms 112, 126 include longitudinal members 138, 140 respectively which are integrated (i.e., connected) to the bracket 116.

A pivot member 142 is also detachably and rotatably fastened to the top surface 144 of the bracket 116 using the pivoting fastener 143. The pivot member 142 can be used for accommodating weight of a user when the user stands on the bracket 116 and/or the pivot member 142. It should be noted that the trailer step bracket 100 has a one-piece construction with only the pivot member 142 as the detachable component. Further, the horizontal arms 112, 126 extend behind the long arms 106, 118 respectively such that the bracket 116 is disposed behind the mounting plates 102, 104. The trailer step bracket 100 is mounted on a trailer using the mounting plates 102, 104 such that the mounting plates 102, 104 are secured to the trailer.

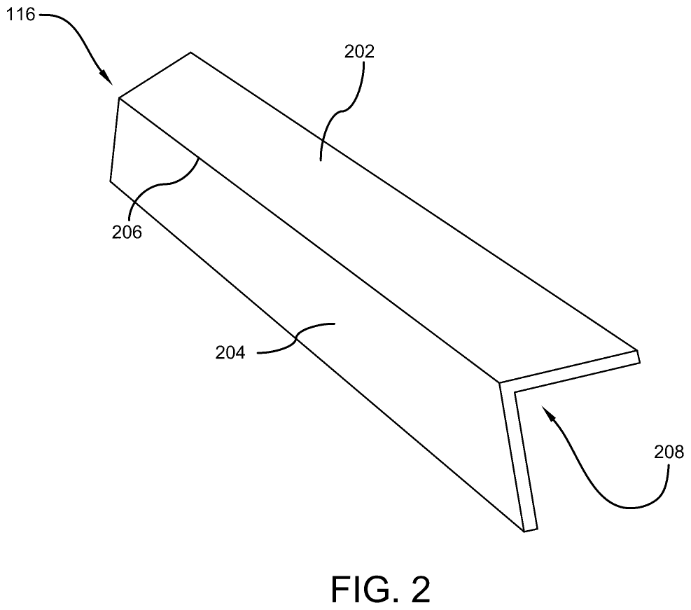

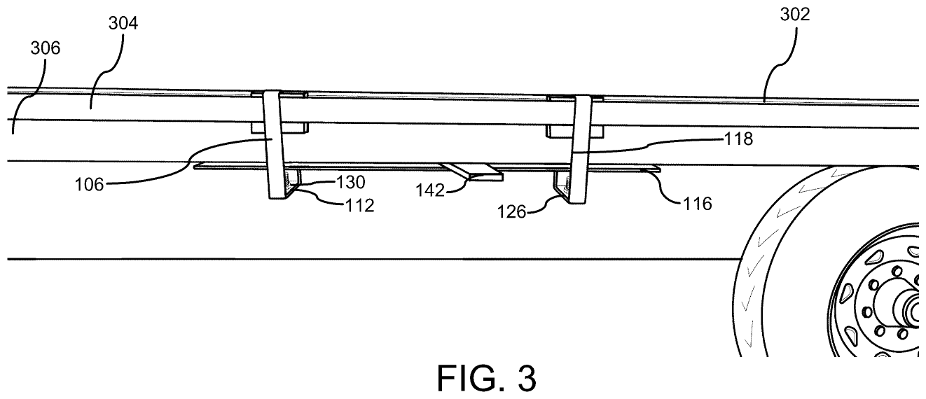

FIG. 2 illustrates a standalone view of the bracket 116 used in the trailer step bracket of the present invention in accordance with the disclosed structure. The bracket 116 is preferably L-shaped and includes a first member 202 and a corresponding transverse member 204 which extends transversely from the edge 206 of the first member 202. The first member 202 is substantially horizontal and parallel to ground when the trailer step bracket is mounted to a trailer as illustrated in FIG. 3. The longitudinal members 138, 140 are integrated (i.e., connected) to the bottom surface 208 of the first member 202, thereby providing support to the bracket 116.

FIG. 3 illustrates a perspective view showing the trailer step bracket mounted to a trailer for safe use in accordance with the disclosed structure. As illustrated, the trailer step bracket 100 is secured to the trailer 302 such as at the side surface 304 of the trailer 302. The trailer step bracket device 100 is mounted to the trailer 302 using the mounting plates 102, 104 such that the long arms 106, 118 are positioned on the outer surface 306 of the trailer 302. The horizontal arms 112, 126 extend below the trailer 302 and the pivot member 142 is positioned transverse to the bracket 116 enabling a portion of the pivot member 142 to extend out from under the trailer 302, thereby enabling a user to step thereon for easy entry or exit from the trailer.

The apertures 130, 132 are easily accessible to a user for securing fold-out camper or trailer steps. The steps can also be fastened before mounting the bracket device 100 to the trailer 302. The bracket device 100 expands the steps for easy access onto and off the trailer.

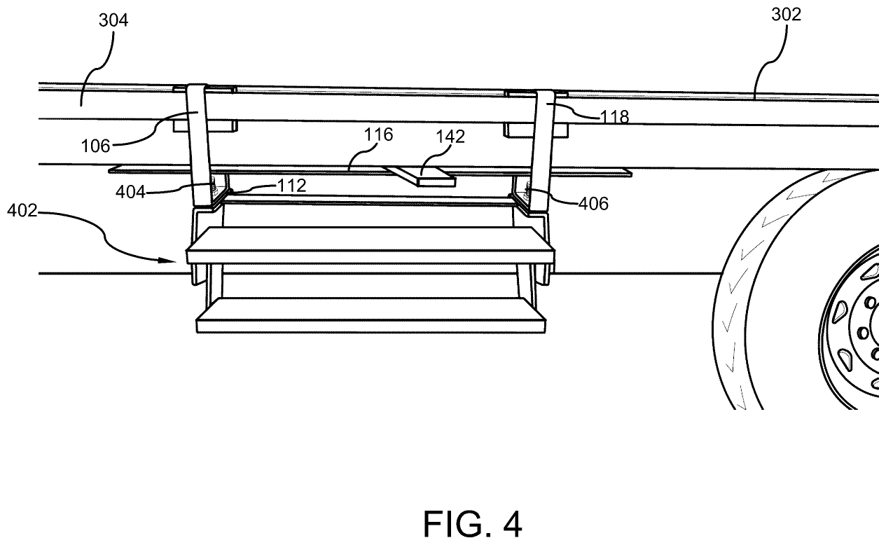

FIG. 4 illustrates a perspective view showing use of the trailer step bracket device of the present invention to expand the steps for a trailer in accordance with the disclosed structure. The bracket device 100 does not obstruct functionality of the conventional fold-out camper or trailer steps but enables to expand the range of the steps. As illustrated, the fold-out camper or trailer steps 402 is secured to the horizontal arms 112, 126 using a pair of fasteners 404, 406 secured through the apertures 130, 132 such that the fold-out camper or trailer steps 402 is positioned below the device 100. A user can expand or fold the steps easily and can use the bracket device 100 along with the fold-out camper or trailer steps 402 to step up or step down. The bracket device 100 is detachably positioned on the trailer 302 and provides a safe and convenient way to enter and exit the trailer.

The bracket device 100 is preferably made of steel or aluminum or any material that offers high strength and durability for supporting heavy weights. The bracket device 100 can be powder coated or galvanized and is resistant to scratches, chipping, and fading. The bracket device 100 can have a width to accommodate standard fold-out steps, around 4 to 12 inches. The bracket device 100 can support about 300 to 500 pounds to accommodate users and potential loads they may carry. In some embodiments, the device 100 may have reflective strips or markings for visibility in low light conditions.

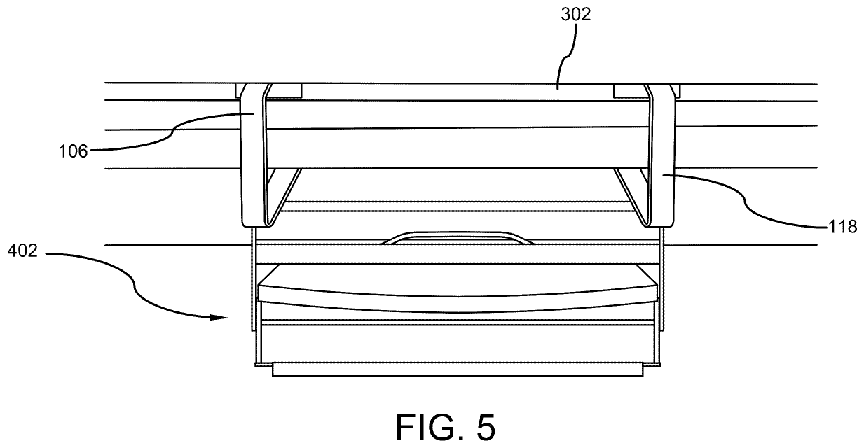

FIG. 5 illustrates a perspective view showing the enhanced trailer access system of the present invention with the steps in a folded state in accordance with the disclosed structure. The steps 402 can be folded back when not required and is not required to be detached from the bracket device 100. The device 100 along with the fold-out camper or trailer steps 402 can be used with all types of trailers by improving safety when entering and exiting a trailer, RV, etc., and minimizing physical effort needed to climb onto the trailer or vehicle.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “enhanced trailer access system”, “trailer step bracket”, “trailer step bracket device”, and “bracket device” are interchangeable and refer to the trailer step bracket device 100 of the present invention.

Notwithstanding the forgoing, the trailer step bracket device 100 of the present invention can be of any suitable size and configuration as is known in the art without affecting the overall concept of the invention, provided that it accomplishes the above stated objectives. One of ordinary skill in the art will appreciate that the trailer step bracket device 100 as shown in the FIGS. are for illustrative purposes only, and that many other sizes and shapes of the trailer step bracket device 100 are well within the scope of the present disclosure. Although the dimensions of the trailer step bracket device 100 are important design parameters for user convenience, the trailer step bracket device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A trailer step bracket comprising:
a first mounting plate;
a second mounting plate;
a first step supporting horizontal arm;
a second step supporting horizontal arm;
a bracket;
a first longitudinal member; and
a second longitudinal member;
wherein said first plate having a first long arm and a first parallel short arm;
wherein said first long arm and said first parallel short arm connected by a first transverse arm at a top end of said first long arm and a top end of said first parallel short arm;
wherein said first step supporting horizontal arm extending from a bottom end of said first long arm to a bottom end of said first longitudinal member;
wherein said second plate having a second long arm and a second parallel short arm;
wherein said second long arm and said second parallel short arm connected by a second transverse arm at a top end of said second long arm and a top end of said second parallel short arm;
wherein said second step supporting horizontal arm extending from a bottom end of said second long arm to a bottom end of said second longitudinal member;
wherein said bracket attached to a top end of said first longitudinal member and to a top end of said second longitudinal member;
wherein said first step supporting horizontal arm having a first aperture;
wherein said second step supporting horizontal arm having a second aperture; and
further wherein a fold-out camper step securable to said first aperture and said second aperture for mounting the fold-out camper step to the trailer step bracket.

2. The trailer step bracket of claim 1, wherein said bracket is horizontal.

3. The trailer step bracket of claim 2, wherein said bracket transverse to said first step supporting horizontal arm and said second step supporting horizontal arm.

4. The trailer step bracket of claim 3 further comprising a pivot member, wherein said pivot member having a pivoting fastener rotatably fastened to a top surface of said bracket.

5. The trailer step bracket of claim 4, wherein said pivot member selectively detachable from said bracket.

6. The trailer step bracket of claim 5, wherein said pivot member supportable of a weight of a user of the trailer step bracket.

7. The trailer step bracket of claim 6, wherein said first mounting plate and said second mounting plate mountable to a trailer.

8. The trailer step bracket of claim 7, wherein said first step supporting horizontal arm and said second step supporting horizontal arm extend behind said first long arm and said second long arm.

9. The trailer step bracket of claim 8, wherein said bracket having an L-shape including a first member and a second member transverse to said first member.

10. The trailer step bracket of claim 9, wherein said first member horizontal and parallel to the ground when the trailer step bracket is mounted to a trailer.

11. The trailer step bracket of claim 10, wherein said first longitudinal member and said second longitudinal member connected to a bottom surface of said first member of said bracket.

12. A trailer step bracket comprising:
a first mounting plate;
a second mounting plate;
a first step supporting horizontal arm;
a second step supporting horizontal arm;
a bracket;
a first longitudinal member; and
a second longitudinal member;
wherein said first plate having a first long arm and a first parallel short arm;
wherein said first long arm and said first parallel short arm connected by a first transverse arm at a top end of said first long arm and a top end of said first parallel short arm;
wherein said first step supporting horizontal arm extending from a bottom end of said first long arm to a bottom end of said first longitudinal member;
wherein said second plate having a second long arm and a second parallel short arm;
wherein said second long arm and said second parallel short arm connected by a second transverse arm at a top end of said second long arm and a top end of said second parallel short arm;
wherein said second step supporting horizontal arm extending from a bottom end of said second long arm to a bottom end of said second longitudinal member;
wherein said bracket attached to a top end of said first longitudinal member and to a top end of said second longitudinal member;
wherein said first step supporting horizontal arm having a first aperture;
wherein said second step supporting horizontal arm having a second aperture;
wherein a fold-out camper step securable to said first aperture and said second aperture for mounting the fold-out camper step to the trailer step bracket;
wherein said first long arm and said second long arm are positioned on an outer surface of the trailer; and
further wherein said first step supporting horizontal arm and said second step supporting horizontal arm extend below the trailer when the trailer step bracket is mounted to a trailer.

13. The trailer step bracket of claim 12, wherein said bracket transverse to said first step supporting horizontal arm and said second step supporting horizontal arm.

14. The trailer step bracket of claim 12 further comprising a pivot member, wherein said pivot member having a pivoting fastener rotatably fastened to a top surface of said bracket.

15. The trailer step bracket of claim 14, wherein said pivot member selectively detachable from said bracket.

16. The trailer step bracket of claim 15, wherein said pivot member supportable of a weight of a user of the trailer step bracket.

17. The trailer step bracket of claim 16, wherein said first mounting plate and said second mounting plate mountable to a trailer.

18. The trailer step bracket of claim 17, wherein said first step supporting horizontal arm and said second step supporting horizontal arm extend behind said first long arm and said second long arm.

19. The trailer step bracket of claim 18, wherein said bracket having an L-shape including a first member and a second member transverse to said first member.

20. A trailer step bracket comprising:
a first mounting plate;
a second mounting plate;
a first step supporting horizontal arm;
a second step supporting horizontal arm;
a bracket;
a first longitudinal member;
a second longitudinal member; and
a pivot member;
wherein said first plate having a first long arm and a first parallel short arm;
wherein said first long arm and said first parallel short arm connected by a first transverse arm at a top end of said first long arm and a top end of said first parallel short arm;
wherein said first step supporting horizontal arm extending from a bottom end of said first long arm to a bottom end of said first longitudinal member;
wherein said second plate having a second long arm and a second parallel short arm;
wherein said second long arm and said second parallel short arm connected by a second transverse arm at a top end of said second long arm and a top end of said second parallel short arm;
wherein said second step supporting horizontal arm extending from a bottom end of said second long arm to a bottom end of said second longitudinal member;
wherein said bracket attached to a top end of said first longitudinal member and to a top end of said second longitudinal member;
wherein said first step supporting horizontal arm having a first aperture;
wherein said second step supporting horizontal arm having a second aperture;
wherein a fold-out camper step securable to said first aperture and said second aperture for mounting the fold-out camper step to the trailer step bracket;
wherein said first long arm and said second long arm are positioned on an outer surface of the trailer;
wherein said first step supporting horizontal arm and said second step supporting horizontal arm extend below the trailer when the trailer step bracket is mounted to a trailer;
wherein said pivot member having a pivoting fastener rotatably fastened to a top surface of said bracket;
wherein said pivot member supportable of a weight of a user of the trailer step bracket; and
further wherein said pivot member transverse to said bracket enabling a portion of said pivot member to extend out from under the trailer for enabling a user to step thereon for easy entry or exit from the trailer.
